(19) United States
(12) Patent Application Publication
(10) Pub. No.: US 2006/0209213 A1
(43) Pub. Date: Sep. 21, 2006

(54) Using an electronic paper-based screen to improve contrast

(75) Inventor: Keith Baker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/551,015

(22) PCT Filed: Mar. 26, 2004
(86) PCT No.: PCT/IB04/50344

§ 371 Date: Sep. 29, 2005

(30) Foreign Application Priority Data
Apr. 4, 2003 (EP) 03100899.8

(51) Int. Cl. H04N 9/74

(52) U.S. Cl. 348/578

(57) ABSTRACT

The invention relates to a projection video system, which comprises a control system for receiving an input video stream. In order to improve the visibility of a projected image so that the projection video system can be satisfactorily used in illuminated rooms, the control system splits the video stream into a first and a second group of image components, 5 and the projection video system further comprises an electronic paper screen system for generating images created by the first group of image components and a projector system for projecting images created from the second group of image components onto the electronic paper screen.

### FIELD OF THE INVENTION

The invention relates to a projection television system, and more particularly to a method and apparatus for using an electronic paper-based screen to improve the contrast of the video images projected by the projection television.

### BACKGROUND OF THE INVENTION

A front projection video system displays an image by directing the projected light from a projector onto a projection screen which diffusely reflects the light back into the viewing area. An example of a front projection video system 100 is illustrated in FIG. 1. A video stream, which is to be displayed, is sent to a control system 101. The control system processes the video stream in known manner and applies the processed video stream to a projector 102. The projector projects the processed video stream onto a screen 103.

An advantage of front projection systems is that the video projection screen 103, which is a thin, wall-mountable unit, is separate from the video projector 102, which can be mounted in various positions within a room. A significant disadvantage of prior front projection video systems is the need for a darkened room in order to achieve an image with tolerable contrast on the projection screen. A darkened room is required because light from the projector 102 as well as ambient light in the room is effectively returned from the screen 103, thereby yielding poor contrast to the viewer. Under normal lighting conditions in a room, the picture quality of the front projection video systems is poor compared to the picture quality of rear projection video systems.

For locations such as hotel lobbies, bars, classrooms, conference rooms, etc., where the placement flexibility of front projection video systems would make their usage desirable, the darkened conditions that are necessary for an image of a good quality are totally unacceptable. Thus, there is a need for a front projection video system which has improved contrast so that the front projection video system can be satisfactorily used in illuminated rooms.

### OBJECT AND SUMMARY OF THE INVENTION

It is an object of the invention to enhance the overall clarity of video images projected onto an electronic paper screen by controlling the electronic paper screen to display high contrast image components of the video images being projected by a projection system.

According to one embodiment of the invention, a method and apparatus for displaying a video image on an electronic paper screen is disclosed. An input video image is divided into a first group of image components and a second group of image components. A first image is generated on the electronic paper screen, using the first group of image components. A second image is projected onto the electronic paper screen, using the second group of image components, wherein the second image overlays the first image.

These and other aspects of the invention are apparent from and will be elucidated with reference to the embodiments described hereafter.

### BRIEF DESCRIPTION OF THE DRAWINGS

The invention will now be described, by way of example, with reference to the accompanying drawings, wherein:

FIG. 1 is a block-schematic representation of a known front projection video system;

FIG. 2 is a block-schematic representation of a known electronic paper system;

FIG. 3 is a block-schematic representation of a front projection video system according to one embodiment of the invention;

FIG. 4 is a block-schematic representation of a control system for a front projection video system according to one embodiment of the invention;

FIG. 5 illustrates an image projected by the front projection video system according to one embodiment of the invention; and

FIG. 6 illustrates an image created by the electronic paper screen according to one embodiment of the invention.

### DESCRIPTION OF EMBODIMENTS

The invention combines the technology of front projection video systems with electronic paper to create a new hybrid front projection display system that amalgamates the advantages of both techniques.

The invention relates to addressable, reusable, paper-like visual displays, such as “gyricon” (or twisting particle) displays or other forms of electronic paper, such as particle electrophoretic displays, but the invention is not limited thereto. A gyricon display, also called a twisting-ball display, rotary ball display, particle display, bipolar particle light valve, etc., offers a technology for making a form of electric paper and other electronically controlled displays. Briefly, a gyricon display is an addressable display made up of a multiplicity of optically anisotropic particles, with each particle being selectively rotatable to present a desired surface to an observer. For example, a gyricon display can incorporate “balls” where each ball has two distinct hemispheres, one black and one white, with each hemisphere having a distinct electrical characteristic (e.g., zeta potential with respect to a dielectric fluid) so that the ball is electrically as well as optically anisotropic. The balls are electrically dipolar in the presence of the fluid and are subject to rotation. A ball can be selectively rotated within its respective fluid-filled cavity, for example, by application of an electric field, so as to present either its black or its white hemisphere to an observer viewing the surface of the sheet of electric paper.

A reflective image is formed by the pattern collectively created by individual black and white hemispheres. By the application of an electric field addressable in two dimensions (as in a matrix addressing scheme), the black and white sides of the balls are controlled as image elements (e.g., pixels or subpixels) of a display image. Alternatively, the display may be controlled by shaped electrodes to form one or more fixed images.

The balls are typically embedded in a sheet of optically transparent material, such as an elastomer sheet. A dielectric fluid, such as a dielectric plasticizer, is used to swell the elastomer sheet containing the balls. Through this swelling, the dielectric fluid effectively creates a fluid-filled cavity around each ball. The fluid-filled cavity accommodates the ball and allows the ball to rotate within its respective fluid-filled cavity, yet prevents the ball from migrating within the sheet.

When an electric field is applied to the sheet over a bead, the electrical force on the bead overcomes the frictional adhesion of the bead to the cavity wall and causes the bead to rotate. Once rotation is complete, each bead will remain in a fixed rotational position within its cavity. Thus, even after the electric field is removed, the structures (balls) will stay fixed in position until they are dislodged by another electric field. This bistability of the beads enables the gyricon display to maintain a fixed image without power. The bistability of the gyricon display is beneficial as compared to other types of displays such as a liquid crystal display or a light-emitting diode display which consume energy to maintain the image.

Gyricon displays are not limited to black and white images, as gyricon and other display mediums are known in the art to have incorporated color. Gyricon displays have been developed, incorporating either bichromal color, trichromal color, or four quadrant colored balls, or three or four segmented colored balls. The colored balls can be charged by adsorption of ions from a liquid onto the ball surface. Alternatively, colored balls can be charged by electret formation by injection of an external charge into the surface region of the colored ball.

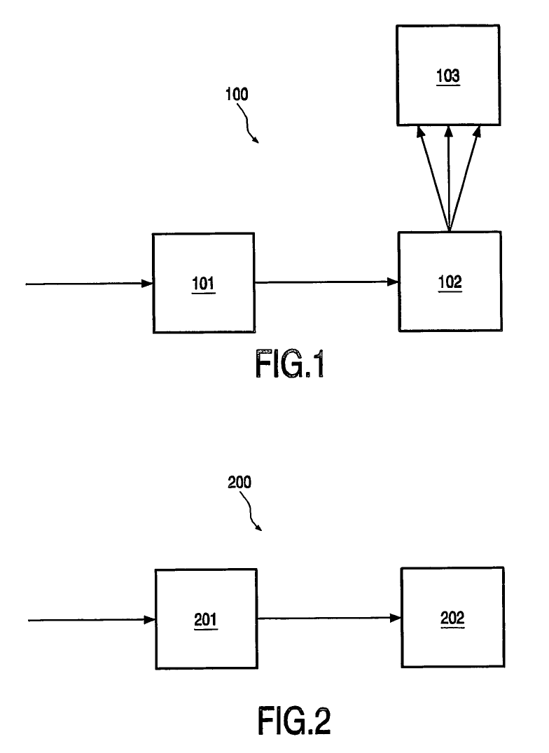

FIG. 2 illustrates a known electronic paper screen 200. The image information is sent to a control system 201. The control system 201 analyzes the incoming image data and determines how the electronic paper screen 202 needs to be charged to create the image. The electronic paper screen 202 is then charged in an appropriate manner to create the image on the screen. While electronic paper technology has proved to provide excellent contrast with low power, electronic paper technology cannot project a fast moving image.

According to one embodiment of the invention, the input data stream to be displayed on a screen is split into two component images. The first component image has coarse-feature, static high contrast image components which will be extracted and created by the electronic paper screen. The second component image has fine-feature, fast moving, colored components according to one embodiment of the invention. These components of the video image will be generated by the projection image system and projected onto the electronic paper screen. Thus, the second image components produced by the projection system will overlay the first image components created and displayed by the electronic paper screen.

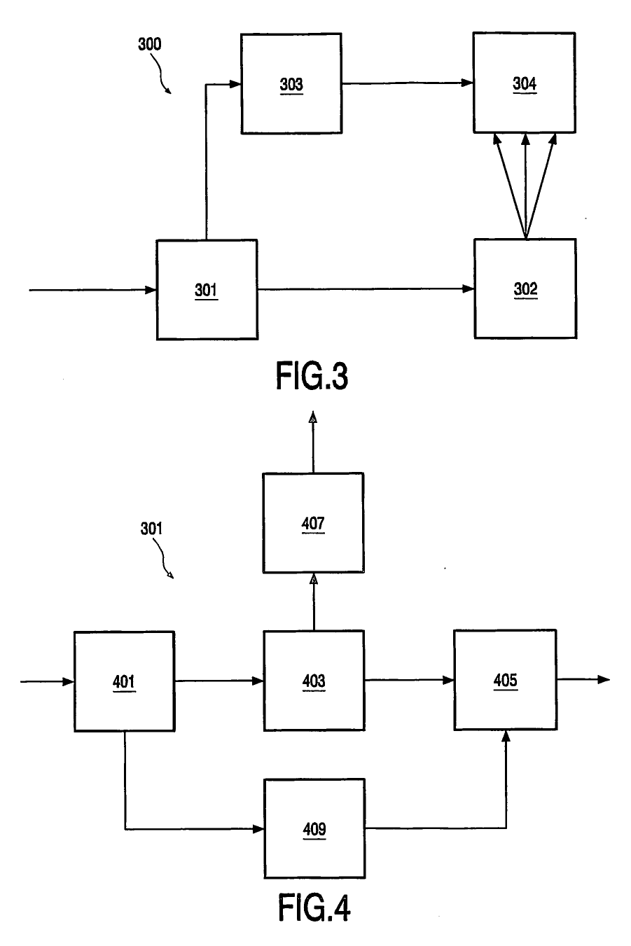

A front projection video system 300 according to one embodiment of the invention will now be described with reference to FIG. 3. The input video stream to be displayed is sent to the control system 301. The input video stream can be provided from a multitude of sources such as a DVD, tape, live video feed via cable or wireless links, etc. The control system 301 is illustrated in FIG. 4 in more detail. The input video stream is received by a receiver 401. The input video stream is then sent to an image splitter 403. The image splitter 403 analyzes the input video stream and splits the video stream into the two image components described above. Specifically, the image splitter 403 sends fine-feature, fast moving colored components to a processing system 405 which controls the images sent to the projector system 302. The image splitter 403 also sends the coarse-feature, static high contrast image components to the processing system 407 which controls the images sent to the electronic paper screen 304.

For analog images, the stream of images must be digitized or rendered into a digital form. The standard techniques for image compression should be used for this purpose, i.e. MPEG2 encoding. When rendered into a compressed digital form, the same techniques for splitting the image can be used with analog streams as with the digital streams of images.

For digital images, the process of digitization is not necessary as the image is transmitted in a digital form These digital image formats are commonly based on the MPEG standard for video compression. Alternatively, they may be propriety formats devised for telecommunication or computer applications. Thus, they can be stored and manipulated in a digital form in the processing engine of the display device. To transmit and store the information efficiently, it is necessary to use efficient compression techniques such as those defined in the MPEG or similar standards.

Compression techniques increase the efficiency of storage by removing redundant details in the spatial and temporal information in the stream of images. This is performed in such a manner that the bandwidth is reduced without drastically reducing the quality of the image perceived by the human eye. Compression techniques used in MPEG 2 are based on the principles of both spatial and temporal compression. Using these compression techniques, a simple method of splitting the image for the described invention can be devised, but the invention is not limited thereto.

For the projected image, the normal compressed image data is processed and projected onto the surface in an unmodified form. However, the image sent to the electronic paper screen is compressed again to render an image with less temporal and spatial detail.

The first step in this process is to remove the color data from the image and render a monochrome image. This image is then examined to remove these frames, which include difference data, the so-called P and B-frame in the MPEG 2 streams. These data are removed to leave the I-frames, which contain individually complete static images. A sample of these I-frames is then made to match the refresh rate of the electronic paper screen. If the rate of I-frames is too low, then pseudo I-frame images should be regenerated using the P and B-frame data, in the usual manner of MPEG2 decoding. These sets of I-frames are then individually compressed to remove spatial details that cannot be rendered on the electronic paper screen. Such compression techniques are well defined in the MPEG2 standard. Other compression techniques use similar techniques for spatial compression, and are equally valid.

A bounding box can also be added to the final digital image to create a “black border” around the image on the electronic paper screen. This is necessary to give the human eye a black reference point for the image on the screen. This enhances the perceived contrast of the image to the human eye. The bounding box should frame the images projected on the electronic paper screen. Spatial positioning of the projected image should either arrange this, or the image should be re-positioned on the electronic screen to achieve the same effect.

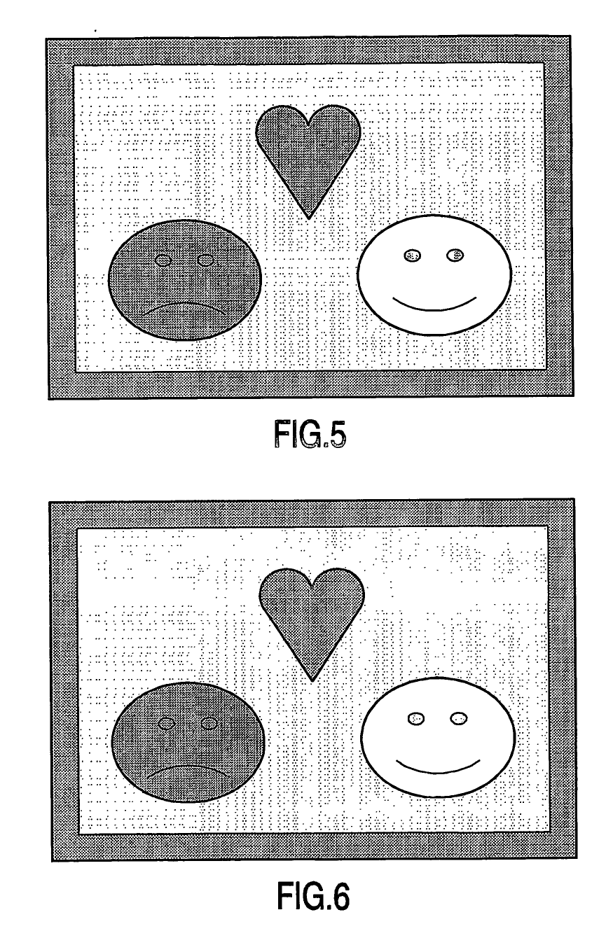

As mentioned above, the light-active components are sent to the projector 302 for projection onto the electronic paper screen 304. FIG. 5 illustrates an image being projected onto an electronic paper screen 304. The coarse static dark features are sent to the control system 303 which drives the electronic paper screen 304 to display these image components in coordination with the image components being projected by the projector 302. It will be understood that, optionally, the control system 303 can be removed and the control system 301 can be used to create the signals to drive the electronic paper screen 304, and the invention is not limited thereto. FIG. 6 illustrates an image which is created and displayed by the electronic paper screen.

According to another embodiment of the invention, a compensation image stream can also be created and combined with the image stream being projected by the projector on the electronic paper screen. Due to the artifacts of compression introduced by the imaging splitting process, the image displayed by the electronic paper screen will be inferior to the imaged project by the projection system. These artifacts could be visible to the human eye if they have a sufficiently long duration or a greater spatial size than the resolution of the display. These effects can be compensated by reprocessing the projected image to allow for these artifacts. As illustrated in FIG. 4, a compensation system 409 can create the compensation image stream. The compensation image is created from a model of the characteristics of the electronic paper screen. This compensation image is mixed with the image to be projected by the projector to create a better image on the electronic paper screen.

This compensation is possible by summing the individual I-Frame images generated for the electronic paper screen with the uncompensated monochrome (luminance) I-Frame image generated for the projection system. The difference between the sum of these images and the actual image will be a difference signal image. These differences signal images should then be added per I-frame to the projection system image I-frames to create the compensated projection image sequence. P and B-frames should then be created for the projection image sequences on the basis of the compensated I-frames, and displayed in the normal fashion of MPEG2 images.

Where the match between the electronic paper screen and the projection system in terms of definition and other image aspects is similar, the compensation image will have little impact on the overall image. However, to reduce costs and improve flexibility, the screen and the projection system may not be matched in terms of display attributes. Specifically, the screen could be very coarse in terms of spatial and temporal resolution. These characteristics of the screen can be provided by the processing algorithms based on a model of the interaction of the hybrid projection system, and of the sequence of images.

It will be understood that the different embodiments of the invention are not limited to the exact order of the above-described steps as the timing of some steps can be interchanged without affecting the overall operation of the invention. Furthermore, use of the verb “comprise” and its conjugations does not exclude other elements or steps, and use of the indefinite article “a” or “an” does not exclude a plurality of such elements or steps, while a single processor or other unit may fulfill the functions of several of the units or circuits recited in the claims.

1. A projection video system, comprising:
a control system (301) for receiving an input video stream, wherein the control system splits the video stream into a first and a second group of image components;
an electronic paper screen system (303, 304) for generating images created by the first group of image components;
a projector system (302) for projecting images created from the second group of image components onto the electronic paper screen.

2. The projection video system as claimed in claim 1, wherein said first group of image components has coarse-feature, static high contrast image components.

3. The projection video system as claimed in claim 1, wherein said second group of image components has fine-feature, fast moving colored components.

4. The projection video system as claimed in claim 1, further comprising:
a compensation unit (409) for creating a compensation signal which is combined with the second group of image components before being projected onto the electronic paper screen.

5. The projection video system as claimed in claim 4, wherein said compensation signal compensates for different display attributes between the projector and the electronic paper screen.

6. The projection video system as claimed in claim 4, wherein said compensation signal is added to each I-frame of the second group of image components.

7. The projection video system as claimed in claim 4, wherein said compensation signal is generated by
summing individual I-frame images generated for the first group of image components with an uncompensated monochrome I-frame image generated for the projection system,
subtracting the summed signal from the actual image.

8. The projection video system as claimed in claim 1, wherein said electronic paper screen generates a bounding box around the image on the electronic paper screen.

9. The projection video system as claimed in claim 8, wherein the bounding box is a black border.

10. A method of displaying a video image on an electronic paper screen, the method comprising the steps of:
dividing an input video image into a first group of image components and a second group of image components;
generating a first image on the electronic paper screen, using said first group of image components; and
projecting a second image onto the electronic paper screen, using said second group of image components, wherein the second image overlays the first image.

11. The method as claimed in claim 10, wherein said first group of image components has coarse-feature, static high contrast image components.

12. The method as claimed in claim 10, wherein said second group of image components has fine-feature, fast moving colored components.

13. The method as claimed in claim 10, further comprising the step of:
creating a compensation signal which is combined with the second group of image components before being projected onto the electronic paper screen.

14. The method as claimed in claim 13, wherein said compensation signal compensates for different display attributes between the projector and the electronic paper screen.

15. The method as claimed in claim 13, wherein said compensation signal is added to each I-frame of the second group of image components.

16. The method as claimed in claim 13, wherein said compensation signal is generated by
summing individual I-frame images generated for the first group of image components with an uncompensated monochrome I-frame image generated for the projection system,
subtracting the summed signal from the actual image.

17. The method as claimed in claim 10, wherein said electronic paper screen generates a bounding box around the image on the electronic paper screen.

18. The method as claimed in claim 10, wherein the bounding box is a black border.

19. The method as claimed in claim 10, further comprising the step of: compressing the first group of image components and the second group of image components after dividing the input video image.

20. The method as claimed in claim 19, further comprising the step of: compressing said first group of image components a second time to remove spatial details that cannot be rendered on the electronic paper screen.
